(19) United States
(12) Patent Application Publication
(10) Pub. No.: US 2025/0012757 A1
(43) Pub. Date: Jan. 9, 2025

(54) DIRECT CURRENT NANOELECTRONIC SENSOR

(71) Applicant: The Regents of The University of Michigan, Ann Arbor, MI (US)

(72) Inventors: Zhaohui ZHONG, Ann Arbor, MI (US); Xudong FAN, Saline, MI (US); Wenzhe ZANG, Ann Arbor, MI (US); Zhe LIU, Ann Arbor, MI (US); Girish S. KULKARNI, Ann Arbor, MI (US); Hongbo ZHU, Ann Arbor, MI (US); You WU, Ann Arbor, MI (US)

(73) Assignee: The Regents of The University of Michigan, Ann Arbor, MI (US)

(21) Appl. No.: 18/709,953

(22) PCT Filed: Nov. 15, 2022
(86) PCT No.: PCT/US2022/049940

§ 371 Date: May 14, 2024

Related U.S. Application Data
(60) Provisional application No. 63/280,266, filed on Nov. 17, 2021.

(51) Int. Cl. G01N 27/414; G01N 27/12; G01N 30/64

(52) U.S. Cl. CPC G01N 27/4146; G01N 27/127; G01N 30/64

(57) ABSTRACT

Nearly all existing direct current (DC) chemical vapor sensing methodologies are based on charge transfer between sensor and adsorbed molecules. However, the high binding energy at the charge-trapped sites, which is critical for high sensitivity, significantly slows sensors' response and makes the detection of non-polar molecules difficult. By exploiting the incomplete screening effect of graphene, this disclosure demonstrates a DC graphene electronic sensor for rapid (sub-second) and sensitive (ppb) detection of a broad range of vapor analytes, including polar, non-polar, organic and inorganic molecules. Molecular adsorption induced capacitance change in the graphene transistor is revealed to be the main sensing mechanism. This work provides an avenue for a broad spectrum real-time gas sensing technology and serves as an ideal testbed for probing molecular physisorption on graphene.

### CROSS-REFERENCE TO RELATED APPLICATIONS

This application claims the benefit of U.S. Provisional Application No. 63/280,266, filed on Nov. 17, 2021. The entire disclosure of the above application is incorporated herein by reference.

### FIELD

The present disclosure generally relates to nanoelectronic sensors.

### BACKGROUND

Nanoelectronic sensors based on low dimensional materials benefit from their extremely high surface-to-volume ratio, low power consumption, chemical robustness, and convenient electrical readout. They represent an important emerging technology that potentially has a broad range of applications in environmental protection, industrial safety, and biomedicine. Particularly, graphene stands out with its high carrier mobility and compatibility with existing semiconductor fabrication technologies that can be explored for developing on-chip sensitive nanoelectronic sensors with large intrinsic gain.

In a typical nanoelectronic vapor sensor, molecules adsorbed to the sensor surface modify its electronic properties, thus generating the sensing signal. Chemical sensors using the field effect transistor (FET) design stand out due to their high sensitivity, resulting from the intrinsic gain from the electrostatic gating effect. The current voltage relation for an FET-based sensor can be generally expressed as:

$$I = \frac{μ W}{L} {C}_{g} ( {V}_{g} - {V}_{t h} - \frac{1}{2} {V}_{sd} ) \cdot {V}_{sd} , \qquad ( 1 )$$

where μ is the charge carrier mobility; W and L are the channel width and length, respectively; C_{g} is the gate capacitance; V_{g} is the gate voltage; V_{sd} is the source-drain bias voltage; Vₜₕ is threshold voltage;

$${C}_{g} ( {V}_{g} - {V}_{t h} - \frac{1}{2} {V}_{sd} )$$

gives the charge per unit area within the FET channel induced by gate voltage.

Most nanoelectronic chemical sensors exploit the charge transfer between the absorbed analyte molecules and the sensor, via directly the nanomaterial or indirectly the contact metal. Additional charges to the FET channel thus contribute to the total transistor current:

$${I}_{s e n s o r} = \frac{μ W}{L} [ {C}_{g} ( {V}_{g} - {V}_{t h} - \frac{1}{2} {V}_{sd} ) + {Q}_{m o l} ] {V}_{sd} , \qquad ( 2 )$$

where Qₘₒₗ is the charge transfer between the device and molecules per unit area inside the channel. Therefore, depending on whether the adsorbed molecules are electron donors or acceptors, the changes in the detected current signal can give opposite signs. Such charge transfer behavior tends to happen for molecules with high binding energy to the sensor surface, or at low absorption energy sites resulting from defects. However, slow defect-mediated charge-transfer processes significantly limits those sensors' response to tens to hundreds of seconds. Additionally, most weak polar and non-polar molecules are inherently weak charge donors or acceptors, which further limits the utility of the charge transfer mechanism. Alternatively, analyte binding induced changes in carrier mobility have also been explored for sensing. Previous researches have intentionally introduced more defects or functional groups to enhance coulomb scattering and lower sensor mobility. Under the framework of this mechanism, all the analytes would consistently give negative current changes. Even though in principle this approach can detect both polar and non-polar molecules, it generally has low sensitivity.

There are also other limitations to the aforementioned two mechanisms. For example, chemo-selective coating or functionalization is often required to increase the sensitivity; post-treatments such as vacuum degassing, prolonged heating, and ultraviolet radiation are often needed for baseline regeneration. The resulting sensors are impractical for robust on-site vapor monitoring systems, which require rapid real-time responses at low concentrations and fast sensor regeneration. Hence, novel sensing mechanisms are needed to resolve these fundamental bottlenecks (i.e., the trade-offs between sensitivity and response time) and take full advantages of nanoelectronic sensors.

Recently, using the intrinsic non-linearity of a transistor, a new sensing technology was developed based on heterodyne mixing to investigate the interaction between the alternating current (AC) drive voltage and the induced oscillating molecular dipole moment. By detecting the molecular dipole instead of charge, the heterodyne sensor successfully addresses the fundamental speed-sensitivity trade-off in vapor detection. Despite these achievements, this heterodyne sensor cannot detect non-polar molecules due to its intrinsic dipole moment sensing mechanism; the AC mixing instrumentation is also more complex than traditional direct current (DC) based circuitry.

This section provides background information related to the present disclosure which is not necessarily prior art.

### SUMMARY

This section provides a general summary of the disclosure, and is not a comprehensive disclosure of its full scope or all of its features.

A direct current (DC) nanoelectronic sensor is presented. The nanoelectronic sensor includes: a field effect transistor (FET), an encasement, and a measurement circuit. The channel region of the field effect transistor is comprised of graphene or another suitable nanomaterial. The encasement is formed over an exposed surface of the channel region and defines a flow channel therein, such that the flow channel guides an analyte of interest across the exposed surface of the channel region. The measurement circuit is electrically coupled between the source electrode and the drain electrode and operates to measure change in direct current (DC) between the source electrode and the drain electrode, where magnitude of the DC current change is indicative of quantity of the analyte of interest.

In another aspect, the nanoelectronic sensor includes a field effect transistor, a delivery mechanism, a measurement circuit and an apparatus that guides the analyte of interest across the exposed surface of the channel region of the field effect transistor, where the channel region is comprised of a nanomaterial. The delivery mechanism directs an analyte of interest across an exposed surface of the channel region; and the measurement circuit is electrically coupled between the source electrode and the drain electrode and operates to measure change in direct current (DC) between the source electrode and the drain electrode, where magnitude of the DC current change is indicative of quantity of the analyte of interest. In some instance, the apparatus is further defined as an encasement formed over an exposed surface of the nanomaterial in channel region, the encasement having an inlet configured to receive an analyte of interest and a flow channel defined therein, such that the flow channel guides the analyte of interest across the exposed surface of the channel region.

In yet another aspect, the nanoelectronic sensor includes a dielectric substrate; a top electrode electrically coupled to a top surface of the dielectric substrate; a bottom electrode electrically coupled to a bottom surface of the dielectric substrate; a nanomaterial disposed on a portion of the top surface of the dielectric substrate; an encasement formed over the nanomaterial, the encasement having an inlet configured to receive an analyte of interest and a flow channel defined therein, such that the flow channel guides the analyte of interest over the nanomaterial; and a measurement circuit electrically coupled between the two electrodes and operates to measure impedance changes in alternative current (AC) between the two electrodes, where the magnitude of the AC current change is indicative of quantity of the analyte of interest.

The nanoelectronic sensor may further include a drive source electrically coupled to the gate electrode and applies a DC voltage thereto, and a delivery mechanism that delivers the analyte of interest to the inlet of the encasement. In some instances, the delivery mechanism includes a gas chromatograph.

In one embodiment, the flow channel in the encasement has a serpentine shape. Additionally, the height to width ratio of the flow channel may be in range of 0.001 to 10.

Further areas of applicability will become apparent from the description provided herein. The description and specific examples in this summary are intended for purposes of illustration only and are not intended to limit the scope of the present disclosure.

### BRIEF DESCRIPTION OF DRAWINGS

The drawings described herein are for illustrative purposes only of selected embodiments and not all possible implementations, and are not intended to limit the scope of the present disclosure.

FIG. 1 is a diagram depicting an example of a nanoelectronic sensor in accordance with this disclosure.

FIGS. 2A-2F are diagrams showing the fabrication of a field effect transistor.

FIGS. 3A-3D are diagrams showing the fabrication of the encasement for the nanoelectronic sensor.

FIGS. 4A and 4B are diagrams showing the nanoelectronic sensor.

FIG. 5 is a graph showing the DC current responses of the nanoelectronic sensor to injections of various masses of four groups of analytes: normal alkanes, aromatics, organic polar compounds and inorganics.

FIGS. 6A-6F are graphs showing nanoelectronic sensor responses to different chemical species.

FIG. 7 are graphs showing the nanoelectronic sensor's responses to chloroform, acetone, n-nonane and nitrobenzene when gated at the p-branch (black) and the n-branch (red).

FIG. 8 is a diagrams illustrating an impedance measurement, where the device is configured as a “parallel capacitor” instead of a three-terminal transistor.

FIG. 9 is a graph showing the current response of the parallel capacitor to acetone injection with different mass amounts of 1317 ng, 2633 ng and 3950 ng, from left to right.

FIGS. 10A-10C are top view schematics of flow channel formed in the encasement, where the prototype is show in FIG. 10A, control 1 with the same width and depth as the prototype but with short total length is shown in FIG. 10B, control 2 with the same total area as in the prototype is shown in FIG. 10C.

FIGS. 11A-11C are graphs comparing the prototype device (black) and control 1 (red) with the same mass injection of acetone, n-nonane and 1,2-dichlorobenzene, respectively.

FIGS. 12A-12D are graphs comparing the prototype device (black) and control 2 (red) with the same mass injection of n-nonane, n-pentane, p-xylene and chloroform, respectively.

FIG. 13 is a graph showing the responses of the field effect transistor to chloroform and n-nonane.

FIG. 14 is a graph showing the responses of the nanoelectronic sensor to 313.6 ng acetone with V_{sd} kept at 10 mV, 50 mV, 100 mV, 500 mV, 3 V, and 5 V, respectively.

FIGS. 15A and 15B are graphs showing the temporal response to pentane at 22.9 degrees Celsius and desorption rates in the natural log scale plotted against the corresponding measurement temperatures in an Arrhenius plot.

### DETAILED DESCRIPTION

Example embodiments will now be described more fully with reference to the accompanying drawings. Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

This disclosure presents a fringing capacitance change based sensing mechanism by exploiting the incomplete screening of graphene. Unlike sensors made of metals or bulk semiconductors, the binding of molecules on the surface of graphene leads to changes in the gate capacitance of a field effect transistor (FET) with a graphene channel region, resulting current:

$$I = \frac{μ W}{L} ( {C}_{g} + {C}_{m o l} ) \cdot ( {V}_{g} - {V}_{t h} - \frac{1}{2} {V}_{sd} ) \cdot {V}_{sd} = \frac{μ W}{L} [ {C}_{g} ( {V}_{g} - {V}_{t h} - \frac{1}{2} {V}_{sd} ) + {Q}_{mol} ] {V}_{sd} , \qquad ( 3 )$$

where Cₘₒₗ and Qₘₒₗ are the molecule induced fringing capacitance change and corresponding charge perturbation, respectively. Fringing capacitance changes occur when surface molecules alter the local dielectric environment above the graphene channel, which pulls more charges from the metal contacts. Consequently, the molecular fringing gate effect increases the transconductance of the FET by coupling with its back gate voltage. Importantly, instead of being measured directly through impedance spectroscopy, which is usually less sensitive and requires more complicated AC circuitry, this fringing capacitance change (Cₘₒₗ) is first amplified in situ by graphene's high mobility and then measured conveniently as a DC current change. While reference is made throughout this application to graphene, it is readily understood that the broader aspects of this application pertain to other types of nanomaterials, such as carbon nanotubes, two-dimensional semiconductors.

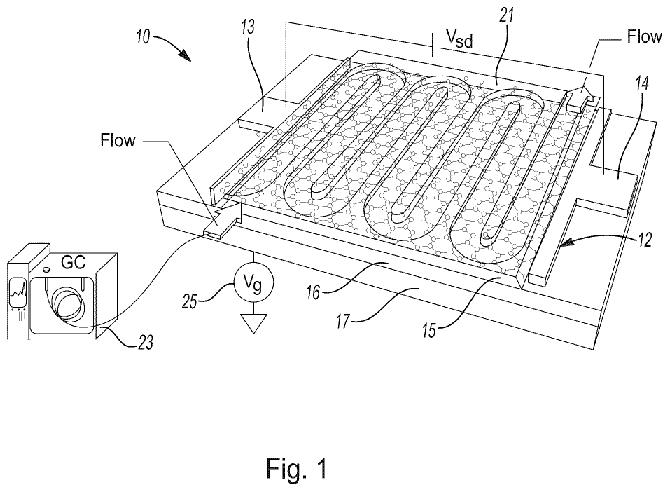

FIG. 1 depicts a direct current (DC) nanoelectronic sensor 10 in accordance with this application. A field effect transistor 12 serves as building clock for the nanoelectronic sensor 10. The field effect transistor 12 includes a source electrode 13, a drain electrode 14, a gate electrode 17, and a channel region 15. The channel region 15 of the field effect transistor 12 is preferably comprised of graphene although other suitable nanomaterials may be used. In this example embodiment, the field effect transistor 12 is form on dielectric substrate 16.

In the example embodiment, an encasement 21 is formed over an exposed surface of the channel region 15. The encasement 21 includes an inlet configured to receive an analyte of interest, an outlet and a flow channel defined therebetween, such that the flow channel is configured to guide the analyte of interest across the exposed surface of the channel region. The flow channel is designed to maximize the interaction between the analyte of interest and the nanomaterial of the channel region. Other types of apparatuses which guide the analyte across the exposed surface of the channel regions also fall within the scope of this application.

To increase interactions, the flow channel should have a height to width ratio in the range of 0.001 to 10. In this regard, height of the flow channel ranges from 1-1000 μm and width of the flow channel ranges from 10 μm-1 mm. The length of the flow channel should also be maximized within the available footprint with a typical length ranging from 0.1 cm to 100 cm. The flow channel is shown as having a serpentine shape although other shapes, such as spiral, are also contemplated by this application.

In the example embodiment, the height of the flow channel is 150 μm, the width of the flow channel is 250 μm and the length of the flow channel is 40 cm. It is readily understood that these parameters are merely exemplary and can vary depending on the sensing application.

A delivery mechanism is interfaced with the flow channel and delivers the analyte of interest to the inlet of the encasement 21. In the example embodiment, delivery mechanism uses gas chromatograph 23 to inject the analyte in a pulsed form. Other delivery mechanisms can be used to inject the analyte in either pulsed or continuous form. For example, a simple pump can be attached to the outlet of the flow channel and operate to pull the analyte into the flow channel. In another example, a sampling loop can be used to inject the analyte into the flow channel.

In the example embodiment, the flow channel of the encasement 21 was connected to a standard benchtop gas chromatograph 23 using a 60-cm long guard column (e.g., part no. 10029, i.d. 250 μm, o.d. 370±5 μm, commercially available from Restek, PA, USA). 1-mm long guard column was inserted into the inlet of the flow channel and a small amount of epoxy adhesive was applied outside to seal and secure the guard column. For vapor sensing, each analyte was injected individually at the GC injection port, where the split ratio was set to be 1:50 and the temperature was set at 250° C. to ensure full vaporization of the injected analyte. The flow rate of carrier gas (Helium) in the guard column was set at 8.5 mL/min. All measurements were carried out in at atmospheric pressure and room temperature.

A drive voltage source 25 is electrically coupled to the gate electrode 17 of the field effect transistor 12 and applied a DC voltage thereto. A measurement circuit is electrically coupled between the source electrode 13 and the drain electrode 14 and operates to measure change in direct current (DC) between the source electrode 13 and the drain electrode 14, where magnitude of the DC current change is indicative of quantity of the analyte of interest.

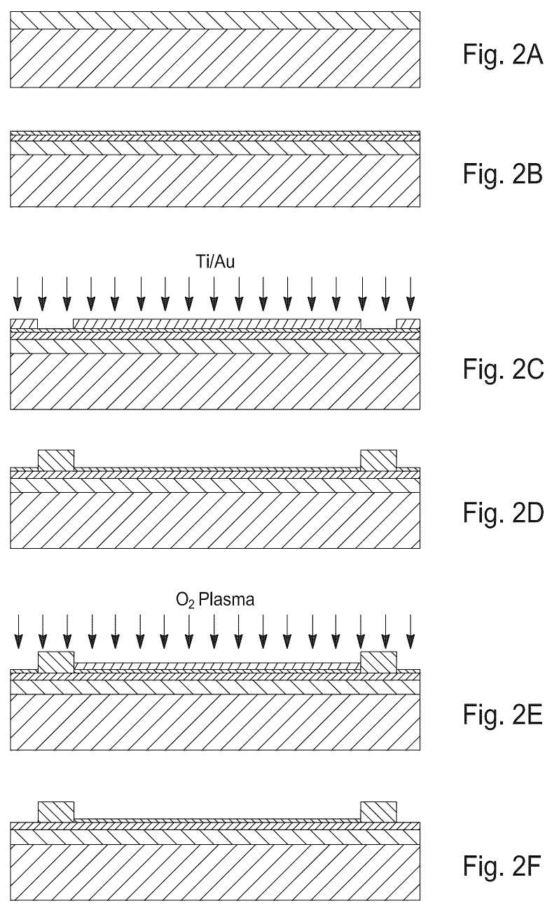

Fabrication of the nanoelectronic sensor 10 is further described in relation to FIGS. 2A-2F, 3A-3D, 4A and 4B. Referring to FIG. 2A, field effect transistor was fabricated on a silicon substrate with 275 nm thermal silicon oxide and 50 nm aluminum oxide subsequently grown by atomic layer deposition (ALD). The Al₂O₃ layer here guarantees the absence of any leakage current between gate and source/drain contacts in these large-area graphene devices. Two layers of CVD graphene were transferred to the substrate to offer complete graphene coverage as seen in FIG. 2B. Single-layer graphene film was first grown on copper foils using chemical vapor deposition. After growth, 950 PMMA (poly(methyl methacrylate)) A2 (Microchem) was spin-coated on one side of the copper substrate and baked at 160° C. for 1 min. Graphene on the uncoated side was removed by 30 sec of O₂ plasma etch and then the sample was placed in 0.1 M ammonium persulfate (Sigma-Aldrich) overnight to etch away the copper as seen in FIG. 2C. For each run of transfer, the PMMA-coated graphene was transferred from solution onto an Al₂O₃/SiO₂/Si substrate and allowed to air dry for a day. The PMMA was removed by placing the die in acetone for 6 hours, then isopropyl alcohol (IPA) for 5 min, followed by nitrogen blow dry. Through photolithography, metal deposition and subsequent lift-off processes using LOR 3A (Microchem) and SPR 220-3.0 (Shipley), 2 nm titanium/100 nm gold source-drain contacts were patterned in FIG. 2D. The graphene channel was patterned using photolithography and 40 sec of O₂ plasma etch as seen in FIG. 2E. A typical device has a graphene channel width of 1.95 cm, and length of 2 cm.

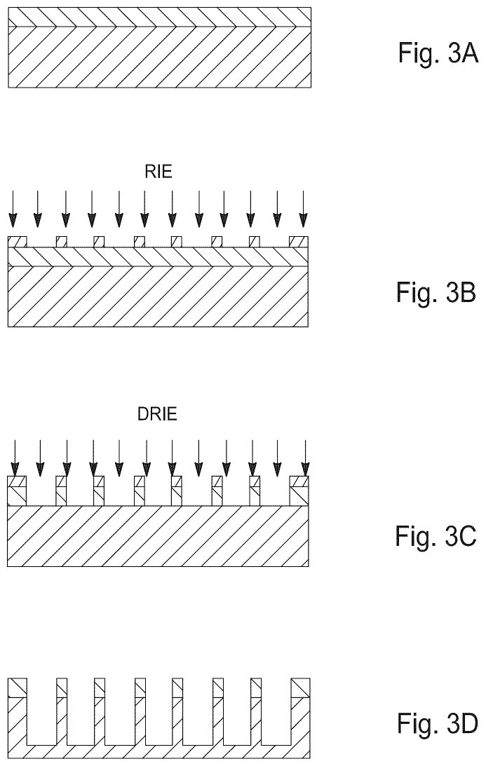

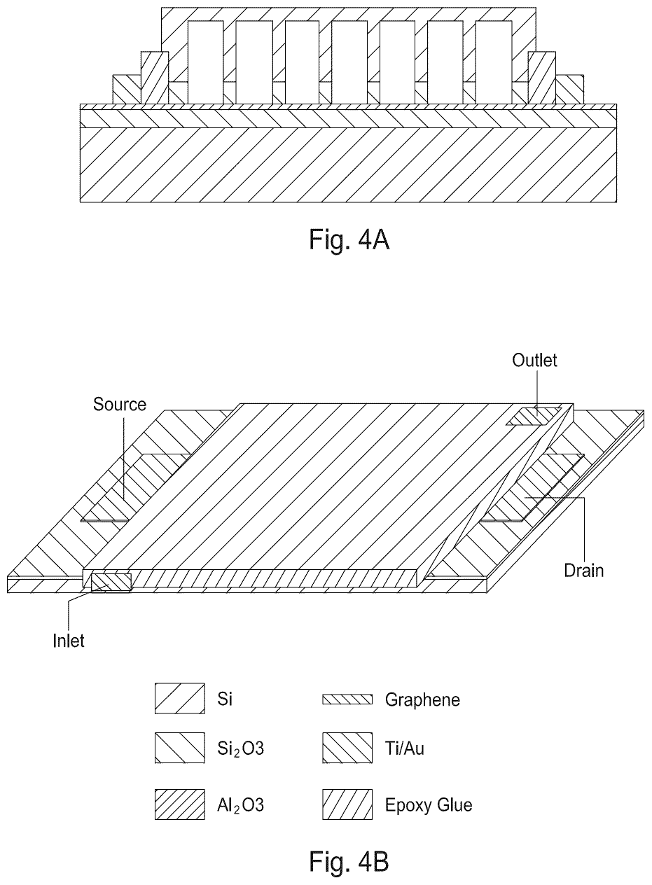

Turning to FIGS. 3A-3D, an example technique is shown for fabricating the encasement 21 for the nanoelectronic sensor 10. In FIG. 3A, the die for the encasement was fabricated on a silicon substrate with 2 μm thick CVD-deposited silicon oxide layer. After photolithography patterning with SPR 220 3.0, silicon oxide was first etched by reactive ion etching (RIE) in FIG. 3B, followed by deep reactive ion etching (DRIE) to create ˜375 μm trenches in FIG. 3C. To strip the photoresist residue and possible coating residue from DRIE, the encasement was treated with 6 min of oxygen plasma and PRS 2000 incubation at 60° C. for 8 hr, IPA for 10 min and deionized water rinse followed by nitrogen blow dry. The encasement 21 and the field effect transistor 12 were then bonded by gluing the surrounding areas, for example with epoxy adhesive (LOCTITE® EA 1C) as seen in FIG. 4A. No adhesion layer was applied between graphene and encasement.

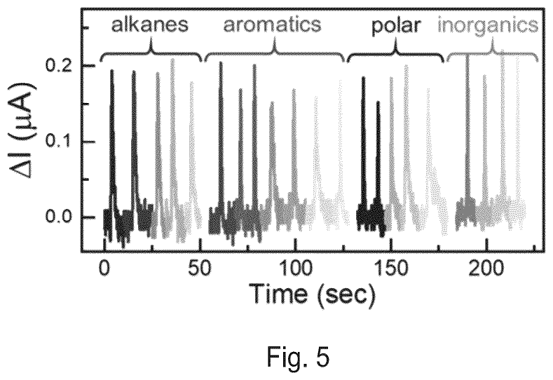

For proof of concept, the nanoelectronic sensor 10 was connected to a benchtop gas chromatography (GC) system that provides sub-second pulsed injection of analytes. The nanoelectronic sensor 10 was then exposed to known amount of analytes, while changes in the source-drain current (I_{sd}) were recorded with V_{g} kept at zero. The sensing response was calculated as the ratio of the transient current change to the baseline current (ΔI_{sd}/I_{sd}). Initial results demonstrated that the sensor showed sharp and strong responses to all tested chemicals, ranging from non-polar, weak polar to strong polar molecules. FIG. 5 shows the DC current response of the nanoelectronic sensor 10 to twenty-one (21) representative chemical species, including normal alkanes (C₅-C₉), benzene, toluene, ethylbenzene, xylenes (o-, m-, and p-), 1,2-dichlorobenzene, acetone, chloroform, ethanol, N,N-dimethylformamide (DMF), dimethyl methylphosphonate (DMMP), carbon monoxide, carbon dioxide, nitric oxide, and hydrogen sulfide. The tested nanoelectronic sensors 10 show instantaneous sub-second response when exposed to pulsed analytes. Furthermore, the nanoelectronic sensor 10 was completely regenerated (i.e., the signal returned to baseline) without any post-treatment.

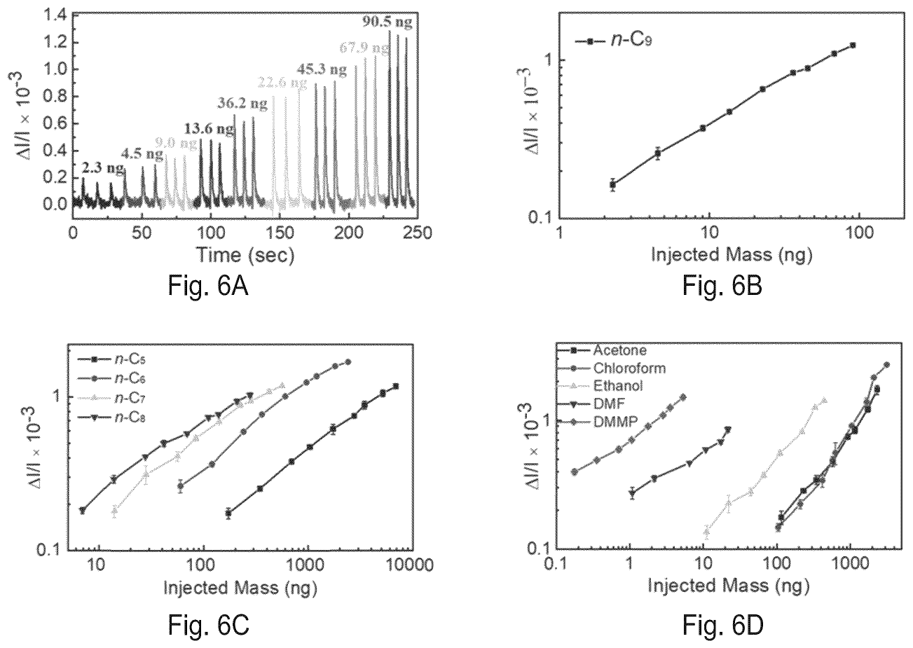

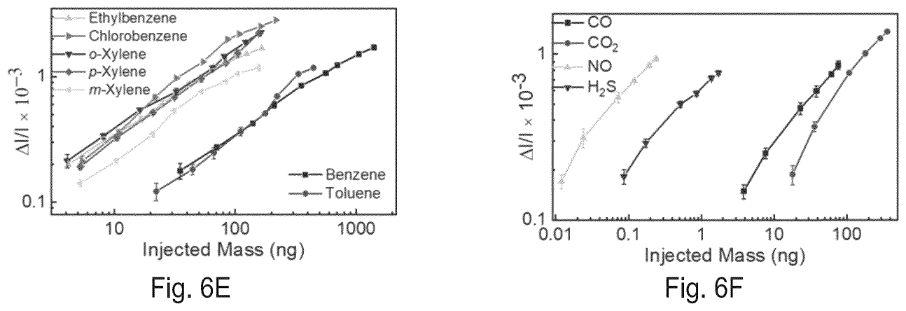

Next, to evaluate the sensor sensing performance, its temporal responses to transient exposure to analytes with varying masses were recorded. The sensor responses (i.e., ΔI_{sd}/I_{sd}) to three repeated doses of n-C₉ with an injection mass from 2.3 ng to 90.5 ng are plotted in FIG. 6A. To estimate the detection limit, sensor dosage response average is plotted in log-log scale (FIG. 6B). The sub-linear response reflects the transient behavior of vapor pulses interacting with the graphene surface and is consistent with previous observations from with other optical sensors and a heterodyne graphene sensor. Using a 30 noise floor (3σ=0.016 μA), the limit of detection (LOD) for n-C₉ is estimated to be 2.1 ng (or 1.7 ppm by volume) at an S/N of 3.

To demonstrate the versatility of the nanoelectronic sensor 10, the sensor's repeated dosage response to additional 20 analytes is demonstrated, including four other alkanes from n-C₆ to n-C₉ (FIG. 6C), seven aromatics (FIG. 6D), four other organic polar molecules (FIG. 6E), and 4 inorganic compounds (FIG. 6F). Table 1 below summarizes the extracted LOD in both mass and volume concentrations for all 21 analytes, together with full width at half maxima (t_{1/2}) at minimum injection amounts and corresponding OSHA standard for 8-hour total weight average (TWA) permissible exposure limits (PEL). In particular, the LOD for DMMP (FIG. 6D) is estimated to be ˜0.050 ng (0.02 ppm in concentration), which represents an improvement of several orders of magnitude over most existing nanoelectronic sensors. Critically, the nanoelectronic sensor 10 is not only capable of detecting most common hazardous air pollutants (e.g., benzene, toluene, ethylbenzene and xylenes) but also achieves sensitivities exceeding the OSHA requirement for long-term exposure limits for nearly all 21 analytes. Therefore, these initial results demonstrate its potential for practical applications in real-time industrial safety monitoring.

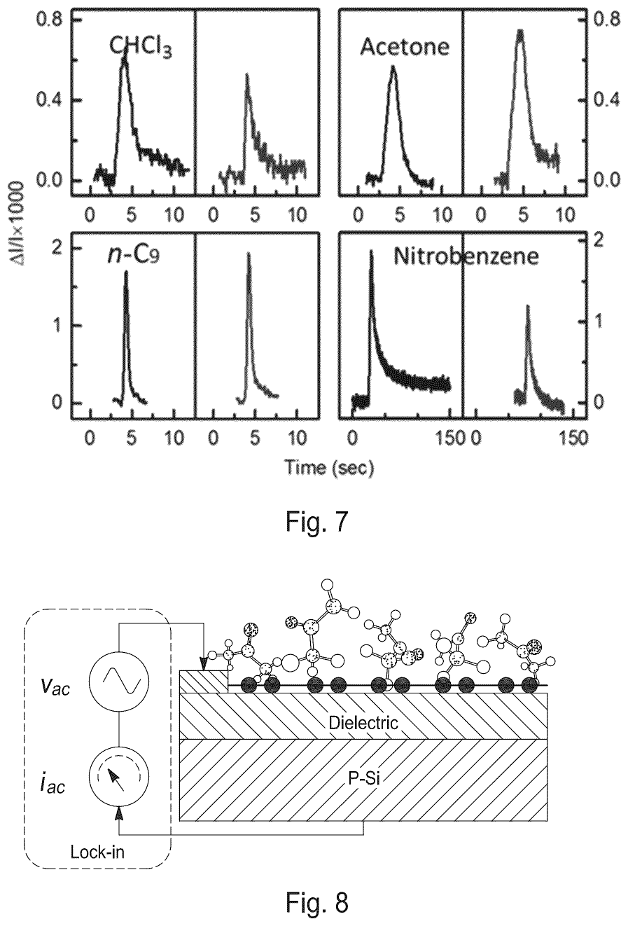

The sensing mechanism for the nanoelectronic sensor 10 can be explained as follows. The change in carrier density in the graphene channel can be induced by either direct charge transfer between graphene and the adsorbate or fringing capacitive gating, in which the analyte changes the local permittivity. In the first case, depending on whether the analyte molecule is an electron donor or acceptor compared to graphene, the sensor current can show a positive or negative peak. Furthermore, due to the intrinsic ambipolarity of graphene, the dominant charge carrier can be either hole at negative V_{g} (with respect to the Dirac point or charge neutral point) or electron at positive V_{g}. Therefore, if charge transfer were the governing mechanism for the sensor current change, some analytes would show positive signals while others negative signals. Furthermore, the sensor signal would flip the sign when V_{g} is held on the opposite side of the Dirac point. As discussed above, a total of 21 analytes were tested on 20 devices. All results consistently show positive signals regardless of the analyte being an electron donor or acceptor. Furthermore, gate-dependent measurements for all tested analytes show positive signal on both sides of the Dirac point, as exemplified in FIG. 7 with chloroform, acetone, n-nonane, and nitrobenzene, which is a strong electron acceptor compared to graphene. These results rule out charge transfer to be the dominant mechanism in the present work.

The fringing capacitive gating effect was also explored as the main mechanism for the nanoelectronic sensor 10. In the case of capacitive gating, the graphene charge carrier density is changed not by direct charge transfer, but by increasing the total gate capacitance when analyte molecules bind to the graphene surface. To confirm this capacitance-effect mechanism, direct two-terminal impedance measurements were conducted between the graphene channel and doped silicon bottom gate as seen in FIG. 8.

FIG. 8 depicts an alternative embodiment for a nanoelectronic sensor. In this embodiment, a top electrode is electrically coupled to a top surface of a dielectric substrate; whereas, a bottom electrode is electrically coupled to a bottom surface of the dielectric substrate. A nanomaterial is also disposed on a portion of the top surface of the dielectric substrate. An encasement is formed over the exposed surface of the nanomaterial. As described above, the encasement includes an inlet configured to receive an analyte of interest, an outlet and a flow channel defined therebetween, such that the flow channel is configured to guide the analyte of interest over the exposed surface of the nanomaterial.

A drive source is electrically coupled across to the top electrode and the bottom electrode and applies an AC signal across the top and bottom electrodes. A measurement circuit is electrically coupled between the two electrodes and operates to measure impedance changes in alternative current (AC) between the two electrodes, where the magnitude of the AC current change is indicative of quantity of the analyte of interest.

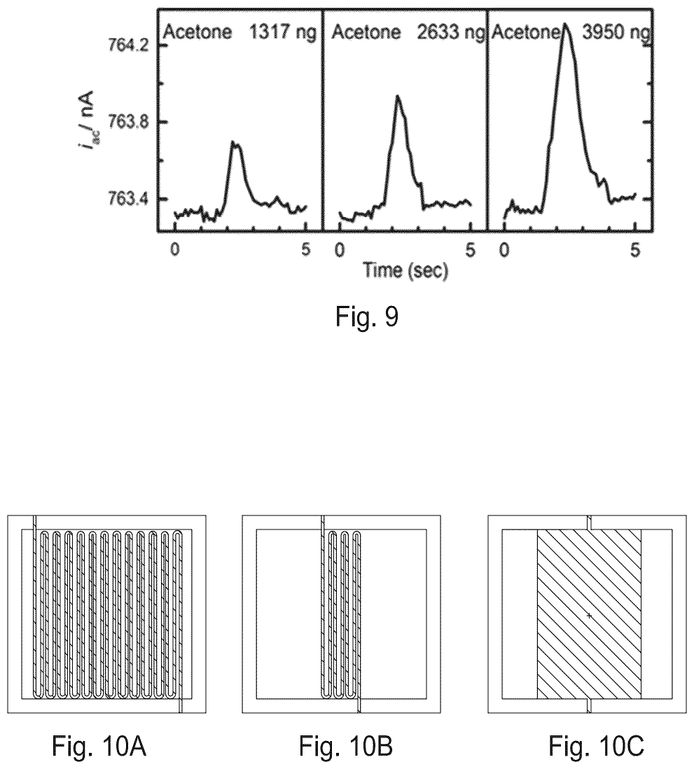

In this embodiment, the nanoelectronic sensor operates as a parallel-plate capacitor instead of a three-terminal transistor. More specifically, the nanomaterial together with the metal contact of the top electrode serves as one plate of the capacitor while the other plate is formed by the heavily doped Si substrate. The time-dependent impedance change is measured after analyte injection using a lock-in amplifier by applying a 95.57 Hz, 0.04 V AC voltage (v_{AC}) across the capacitor. As exemplified in FIG. 9, a significant increase in the AC current was observed after acetone injection. The response increases with increasing acetone mass. Since the parasitic impedance from the measurement setup and the sensor device remain constant during measurement, the increase in the AC current across the two parallel plates can only be explained by the enhanced device capacitance, which is induced by the injected analytes. This result provides direct evidence for the proposed fringing capacitance change based sensing mechanism. Notably, the injection amount had to be nine times higher in FIG. 9 than in FIG. 6 in order to achieve a similar S/N, highlighting the benefit of intrinsic amplification from the field effect transistor.

Next, the sensor responses were measured for three pairs of isomers: (1) cis- and trans-dicholoethylene, (2) 1,2- and 1,3-dichlorobenzene, and (3) 3- and 2-chlorotoluene. Although each pair of isomers have the same chemical constitution, differences in the dipole moment and hence polarizability result in different dielectric constants at the same vapor concentrations, as given by the Clausius-Mossotti equation. For each pair of isomers, even with the same injection mass, the same sensor shows a significantly different sensitivity, which is roughly proportional to the corresponding dielectric constant.

These three control experiments—V_{g}-dependent sensing measurements (at n- and p-branches of Gr-FET), impedance measurements, and isomer measurements, collectively confirm that the fringing capacitive effect, instead of charge transfer, is the dominant sensing mechanism in the nanoelectronic sensor 10. Assuming negligible direct charge transfer between graphene and adsorbed molecules, Cₘₒₗ is solely responsible for the current perturbation after analyte injection. Cₘₒₗ and molecule induced charge perturbation Qₘₒₗ can be estimated as follows,

$${C}_{m o l} = {C}_{g} \cdot \frac{Δ {I}_{s d}}{{I}_{s d}} . \qquad ( 4 )$$

$${Q}_{m o l} = {C}_{m o l} \cdot ( {V}_{g} - {V}_{t h} - \frac{1}{2} {V}_{sd} ) . \qquad ( 5 )$$

Table 3 below summarizes the estimated Cₘₒₗ and Qₘₒₗ of 21 analytes at the minimal injection amount, together with dipole moment and polarizability.

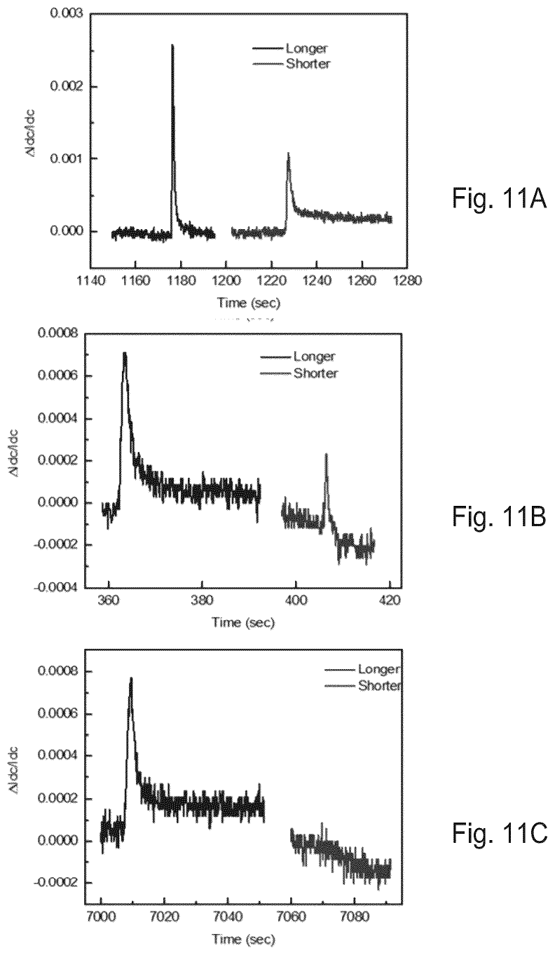

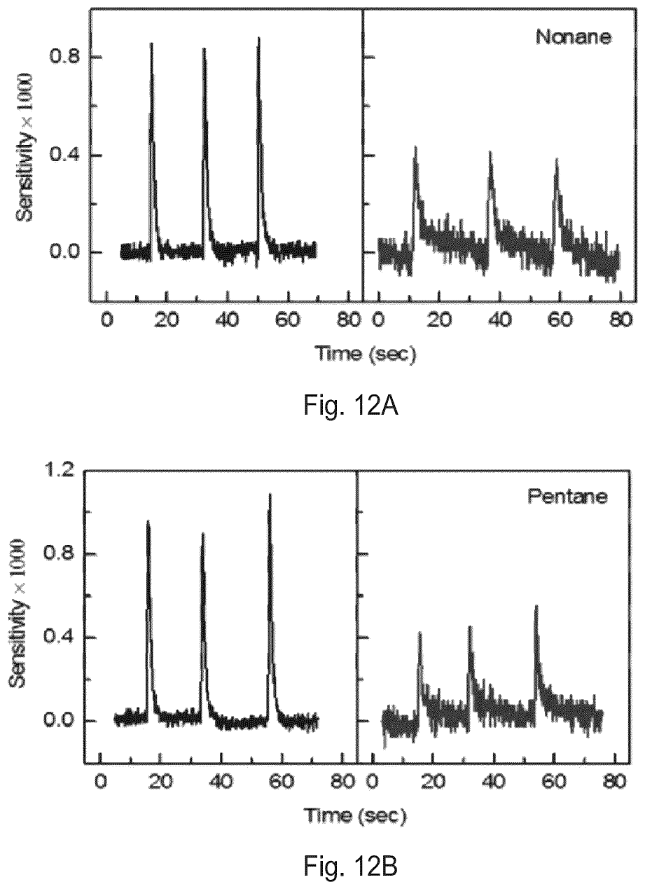

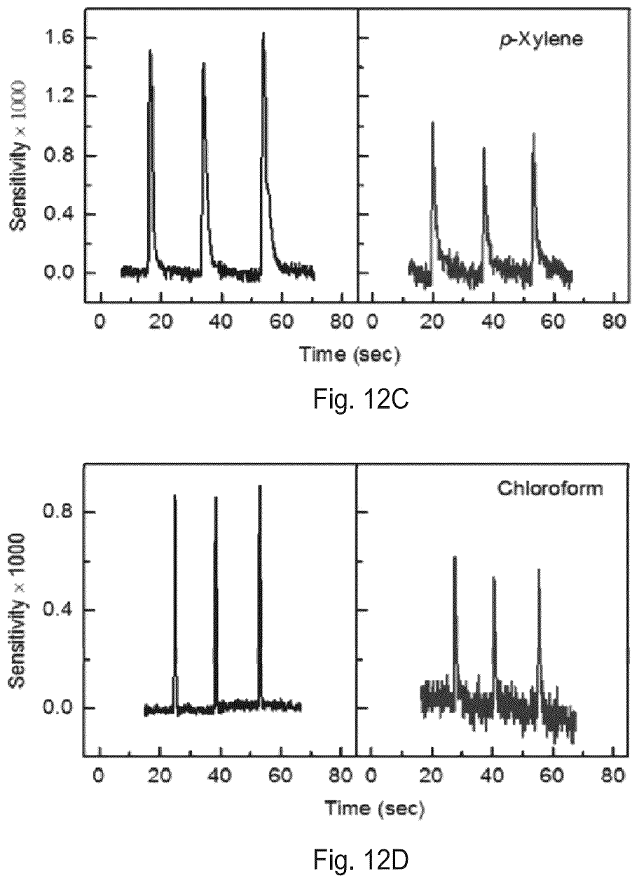

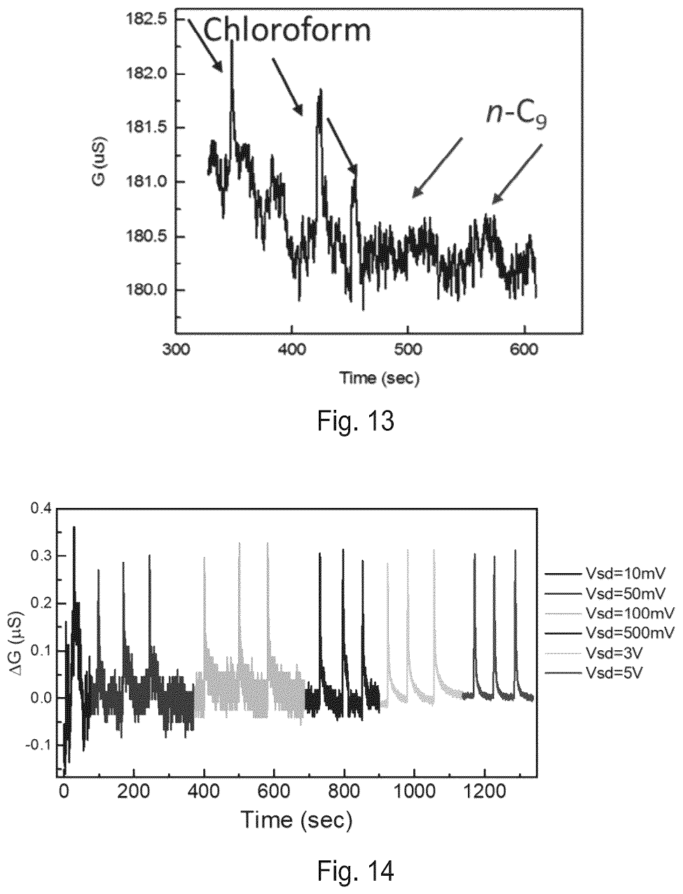

The role of the encasement 21 was also investigated. Flow channels with different shapes and dimensions were designed as controls (Table 4), namely with the same width and depth but a much shorter length of 11.8 cm (FIGS. 10B and 11A-11C), and rectangular shape with the same total area but much shorter in length and wider in width than the prototype encasement (FIGS. 10C and 12A-12D). Control 1 has a lower sensitivity due to the smaller sensing area, which can also be seen in FIG. 13 where the graphene channel area was further reduced from a centimeter scale to 2 μm×2 μm. Control 2 has a lower sensitivity because it has a very wide channel. Given the high volumetric rate (8.5 mL/min) in our experiments, the molecules do not have enough time to fully interact with the graphene surface if the channel is too wide.

The source-drain bias voltage plays an important role in sensitivity enhancement for the nanoelectronic sensor 10. When the bias was increased from 10 mV to 5 V, the signal-to-noise ratio (S/R) of the sensor increased from ˜1 to 27 (FIG. 14). It is noticed that the conductance change toward injection of a given analyte with the same amount remains constant and none of the detection peaks have any tailing issue; this is different from the previous DC sensing work, where sensitivity shows significant dependence on V_{sd} and the signal does not emerge till above a threshold of applied voltage. In those previous works, the sensitivity and reversibility of the sensors were enhanced by a change in the charge transport mode, as in the Poole-Frenkel conduction regime electrons “jump” through the defects instead of bypassing them. In order to limit current going through the device, bias voltage of 3 V was adopted for all sensing performance characterizations in this application, which is sufficient to provide a decent S/N.

Unveiling the van der Waals (vdW) interactions between small molecules and sp² carbon allotropes is important for surface physics and sensor design, as well as in studying the related biological processes. Particularly, the behavior of rigid hydrocarbon chains on IT systems is of special interest in organic synthesis, biochemistry, drug delivery, and hydrocarbon gas storage. To date, most studies are based on theoretical simulations or thermal desorption spectroscopy measurements on graphite. However, these methods might result in deviation of the molecular binding energies compared to those on graphene surfaces. The nanoelectronic sensor 10 of this application offers a more suitable platform to study the interactions between small molecules and the nanomaterials with their sensitive response and electrical readout. However, as previously discussed, the response of conventional nanoelectronic sensors is based on charge-transfer (covalent binding), which does not represent the physicochemical nature of non-covalent vdW interactions near the pristine surface of graphene. Using the heterodyne mixing detection technique, the binding affinity between graphene and five polar molecule specie was quantified. However, the graphene heterodyne sensor is only responsive to polar molecules and unable to probe non-polar molecules.

Unlike other graphene nanoelectronic sensors, the nanoelectronic sensor 10 in this application offers a testbed for characterizing the binding energy of adsorbed non-polar molecules at the graphene surface. The high speed, high sensitivity, and reversible performance enables real-time monitoring of the rapid molecular physisorption behavior. Additionally, this sensor's design keeps both metal contacts and graphene edges outside the flow column, thus allowing the detection signal to unveil the true vdW interaction between the molecules and graphene.

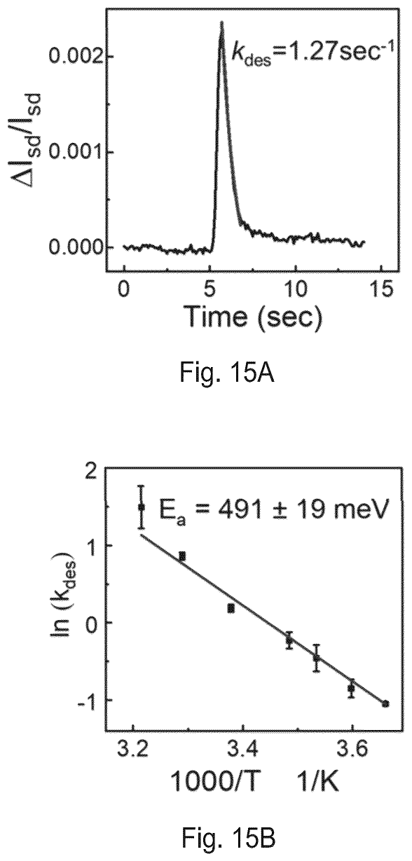

To investigate the hydrocarbon/sp²-carbon interaction, temperature-dependent measurements were conducted on the nanoelectronic sensor 10 for five alkanes (from n-C₆ to n-C₉). Briefly, the device was kept onto a Peltier cooler/heater to allow for device temperature control; for each analyte, time-domain measurements were conducted at different temperatures. The desorption rates are extracted at the first exponential decay of the curve (FIG. 15A) and plotted against corresponding temperatures (FIG. 15B). The binding affinity is then extracted by fitting the slope in Arrhenius scale, according to transition state theory. The experimentally-extracted binding energies of the four alkane chains on graphene are provided in Table 2. Note that the binding energy between n-alkanes and graphene increases with increased chain length, in agreement with increased polarizability. These experimentally extracted values resemble the simulation results on graphene-alkane interactions. However, compared to the modeling work on graphite, the corresponding binding energies of the same alkanes are lowered by ˜200 meV.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

While aspects of the present disclosure have been particularly shown and described with reference to the embodiments above, it will be understood by those skilled in the art that various additional embodiments may be contemplated by the modification of the disclosed dampers without departing from the spirit and scope of what is disclosed. Such embodiments should be understood to fall within the scope of the present disclosure as determined based upon the claims and any equivalents thereof.

### APPENDIX

TABLE 1
Summary of the μColumn Gr-FET sensor in response to 21 polar
and non-polar vapor analytes as well as their 8-hour total
weight average (TWA) permissible exposure limits (PEW) listed
by Occupational Safety and Health Administration (OSHA).

| | | Concentration | | |
|---|---|---|---|---|
| | LOD, | at detection | | OSHA PEL |
| | mass | limit mass | t_{1/2} | 8-hr TWA |
| Analyte | (ng) | (ppm) | (sec) | (ppm) |
| n-C₅ | 128.5 | 162 | 0.6 | 1000 |
| n-C₆ | 19.7 | 56.3 | 1.3 | 500 |
| n-C₇ | 8.0 | 13.6 | 1.4 | 500 |
| n-C₈ | 4.1 | 4.3 | 1.5 | 500 |
| n-C₉ | 2.1 | 1.7 | 1.1 | — |
| Benzene | 24.4 | 46.2 | 1 | 1 |
| Toluene | 39.3 | 37.0 | 0.7 | 200 |
| Ethylbenzene | 2.2 | 5.1 | 0.8 | 100 |
| o-Xylene | 3.7 | 2.2 | 1.7 | 100 |
| m-Xylene | 4.6 | 4.0 | 1.3 | 100 |
| p-Xylene | 4.2 | 3.7 | 1.6 | 100 |
| Chlorobenzene | 1.7 | 4.9 | 0.9 | 75 |
| Acetone | 43.5 | 235.1 | 0.8 | 500 |
| Chloroform | 33.3 | 149.4 | 0.6 | 100 |
| Ethanol | 20.5 | 19.9 | 1.1 | 1000 |
| DMF | 0.43 | 0.7 | 1.6 | 50 |
| DMMP | 0.050 | 0.02 | 2.0 | — |
| Carbon monoxide | 3.5 | 20.0 | 0.7 | 35 |
| Carbon dioxide | 18 | 57.4 | 0.6 | 5000 |
| Nitric oxide | 0.1 | 0.6 | 1.1 | 25 |
| Hydrogen sulfide | 0.8 | 4.2 | 0.9 | 10 |

TABLE 2
Summary of the experimental binding energy, dipole moment,
and polarizability of five tested alkanes⁴².

| | Dipole | | Experimental |
|---|---|---|---|
| | Moment | Polarizability | Binding Energy |
| Analyte | (D) | (α, 10⁻²⁴ cm⁻³) | (meV) |
| n-C₅ | 0 | 9.88 | 491 ± 19 |
| n-C₆ | 0 | 11.63 | 527 ± 15 |
| n-C₇ | 0 | 13.37 | 607 ± 30 |
| n-C₈ | 0 | 15.24 | 684 ± 26 |
| n-C₉ | 0 | 17.37 | 761 ± 30 |

TABLE 3
Estimation of molecule induced capacitance perturbation per unit
area (Cₘₒₗ, nF/cm²), molecular induced charge per unit area
(Cₘₒₗ, nC/cm²) in graphene tabulated along with the minimal analyte
injection mass (mᵢₙⱼ, ng), dipole moment (D, Debye), and
polarizability (α, 10⁻²⁴ cm³). (Data source for D and α:
CRC Handbook of Chemistry and Physics, 102^{nd} Edition).

| Analyte | mᵢₙⱼ | D | α | Cₘₒₗ | Qₘₒₗ |
|---|---|---|---|---|---|
| n-C5 | 171.8 | 0 | 9.88 | 2.03 | 15.2 |
| n-C6 | 59.9 | 0 | 11.63 | 3.05 | 22.9 |
| n-C7 | 14.0 | 0 | 13.37 | 2.10 | 15.7 |
| n-C8 | 6.9 | 0 | 15.24 | 2.11 | 15.9 |
| n-C9 | 2.3 | 0 | 17.37 | 1.89 | 14.2 |
| Benzene | 35.1 | 0 | 10.32 | 2.07 | 15.5 |
| Toluene | 22.2 | 0.375 | 12.26 | 1.41 | 10.6 |
| Ethylbenzene | 4.2 | 0.59 | 14.20 | 2.32 | 17.4 |
| o-Xylene | 4.1 | 0.64 | 14.10 | 2.47 | 18.5 |
| m-Xylene | 5.2 | 0.35 | 14.20 | 1.63 | 12.2 |
| p-Xylene | 5.2 | 0 | 14.20 | 2.22 | 16.6 |
| Chlorobenzene | 5.4 | 1.69 | 12.30 | 2.46 | 18.5 |
| Acetone | 115.7 | 2.88 | 6.39 | 2.05 | 15.3 |
| Chloroform | 104.7 | 1.04 | 8.23 | 1.71 | 12.8 |
| Ethanol | 11.1 | 1.69 | 5.11 | 1.58 | 11.8 |
| DMF | 1.1 | 3.82 | 7.80 | 3.15 | 23.6 |
| DMMP | 0.18 | 3.62 | 10.00 | 4.61 | 34.5 |
| Carbon monoxide | 3.8 | 0.1098 | 1.95 | 1.72 | 12.9 |
| Carbon dioxide | 18.0 | 0 | 2.91 | 2.18 | 16.4 |
| Nitric oxide | 0.012 | 0.15872 | 1.70 | 1.98 | 14.9 |
| Hydrogen sulfide | 0.086 | 0.97833 | 3.78 | 2.11 | 15.9 |

TABLE 4
Summary of the tested μColumn dimensions.

| | | |
|---|---|---|
| Prototype | Control 1 | Control 2 |

| | | | | | | |
|---|---|---|---|---|---|---|
| Lₜₒₜₐₗ | 423.6 | mm | 118.7 | mm | 17.0 | mm |
| W | 400 | □m | 400 | □m | 9967.5 | □m |
| Areaₜₒₜₐₗ | 169 | mm² | 47 | mm² | 169 | mm² |

1. A nanoelectronic sensor, comprising:
a field effect transistor having a source electrode, a drain electrode, a gate electrode, and a channel region, where the channel region is comprised of a nanomaterial;
an encasement formed over an exposed surface of the channel region, the encasement having an inlet configured to receive an analyte of interest and a flow channel defined therein, such that the flow channel guides the analyte of interest across the exposed surface of the channel region; and
a measurement circuit electrically coupled between the source electrode and the drain electrode and operates to measure change in direct current (DC) between the source electrode and the drain electrode, where magnitude of the DC current change is indicative of quantity of the analyte of interest.

2. The nanoelectronic sensor of claim 1 further comprises a drive source electrically coupled to the gate electrode and applies a DC voltage thereto.

3. The nanoelectronic sensor of claim 1 wherein the flow channel in the encasement has a serpentine shape.

4. The nanoelectronic sensor of claim 1 wherein height to width ratio of the flow channel is in range of 0.001 to 10.

5. The nanoelectronic sensor of claim 1 wherein the nanomaterial is graphene.

6. The nanoelectronic sensor of claim 1 further comprises a delivery mechanism that delivers the analyte of interest to the inlet of the encasement.

7. The nanoelectronic sensor of claim 6 wherein the delivery mechanism includes a gas chromatograph.

8. The nanoelectronic sensor of claim 1 wherein the nanomaterial is functionalized to selectively capture more analytes.

9. A sensing system comprised of an array of nanoelectronic sensors disposed on a substrate, where each nanoelectronic sensor is implemented in accordance with claim 1.

10. A nanoelectronic sensor, comprising:
a field effect transistor having a source electrode, a drain electrode, a gate electrode, and a channel region, where the channel region is comprised of a nanomaterial;
a delivery mechanism that directs an analyte of interest across an exposed surface of the channel region;
an apparatus that guides the analyte of interest across the exposed surface of the channel region and is configured to increase interaction between the analyte of interest and the nanomaterial in the channel region; and
a measurement circuit electrically coupled between the source electrode and the drain electrode and operates to measure change in direct current (DC) between the source electrode and the drain electrode, where magnitude of the DC current change is indicative of quantity of the analyte of interest.

11. The nanoelectronic sensor of claim 10 further comprises a drive source electrically coupled to the gate electrode and applies a DC voltage thereto.

12. The nanoelectronic sensor of claim 10 further comprises a drive source electrically coupled to the gate electrode and applies a drive signal with an alternating current thereto.

13. The nanoelectronic sensor of claim 10 wherein the nanomaterial is graphene.

14. The nanoelectronic sensor of claim 10 wherein the apparatus is further defined as an encasement formed over an exposed surface of the nanomaterial in channel region, the encasement having an inlet configured to receive an analyte of interest and a flow channel defined therein, such that the flow channel guides the analyte of interest across the exposed surface of the channel region.

15. The nanoelectronic sensor of claim 1 wherein the nanomaterial is functionalized to selectively capture more analytes.

16. A nanoelectronic sensor, comprising:
a dielectric substrate;
a top electrode electrically coupled to a top surface of the dielectric substrate;
a bottom electrode electrically coupled to a bottom surface of the dielectric substrate;
a nanomaterial disposed on a portion of the top surface of the dielectric substrate;
an encasement formed over the nanomaterial, the encasement having an inlet configured to receive an analyte of interest and a flow channel defined therein, such that the flow channel guides the analyte of interest over the nanomaterial; and
a measurement circuit electrically coupled between the two electrodes and operates to measure impedance changes in alternative current (AC) between the two electrodes, where the magnitude of the AC current change is indicative of quantity of the analyte of interest.

17. The nanoelectronic sensor of claim 16 further comprises a drive source electrically coupled to the top and bottom electrodes and applies an AC signal across the top and bottom electrodes.

18. The nanoelectronic sensor of claim 15 wherein the nanomaterial is graphene.

19. The nanoelectronic sensor of claim 15 wherein the nanomaterial is functionalized to selectively capture more analytes.
